(19) United States
(12) Patent Application Publication
(10) Pub. No.: US 2007/0170286 A1
(43) Pub. Date: Jul. 26, 2007

(54) Injector for injecting fuel into combustion chambers of internal combustion engines, in particular a piezoelectric-actuator-controlled common rail injector

(75) Inventor: Friedrich Boecking, Stuttgart (DE)

Correspondence Address: RONALD E. GREIGG;GREIGG & GREIGG P.L.L.C., 1423 POWHATAN STREET, UNIT ONE, ALEXANDRIA, VA, 22314, US

(73) Assignee: ROBERT BOSCH GMBH, Suttgart (DE)

(21) Appl. No.: 10/578,904

(22) PCT Filed: Sep. 9, 2004
(86) PCT No.: PCT/DE04/02028

§ 371 Date: Feb. 9, 2007

(30) Foreign Application Priority Data
Nov. 14, 2003 (DE) 103 53 169.6

(51) Int. Cl. B05B 1/08; F02M 63/00

(52) U.S. Cl. 239/533.2; 239/102.2

(57) ABSTRACT

A common rail injector for an internal combustion engines has control means including a piezoelectric actuator deposed in an injector body and via at least one booster piston actuates a control valve received in a valve plate. Also provided are a nozzle body having a nozzle outlet on its free end toward the combustion chamber; a nozzle needle located axially movably and actuatably in a longitudinal recess of the nozzle body; a throttle disk, closing off the rear end (remote from the nozzle outlet) of the longitudinal recess and located between the nozzle body and the control valve, which throttle disk forms an opening stop for the nozzle needle and cooperates with the rear end face of the nozzle needle and thus limits the opening stroke of the nozzle needle; and a control chamber between the rear nozzle needle end face and the throttle disk, which chamber is in hydraulic communication with a pressure connection serving to deliver fuel. A substantial special feature is that a cylindrical retaining body is disposed in the injector body and receives the booster piston or pistons and the valve plate that contains the control valve.

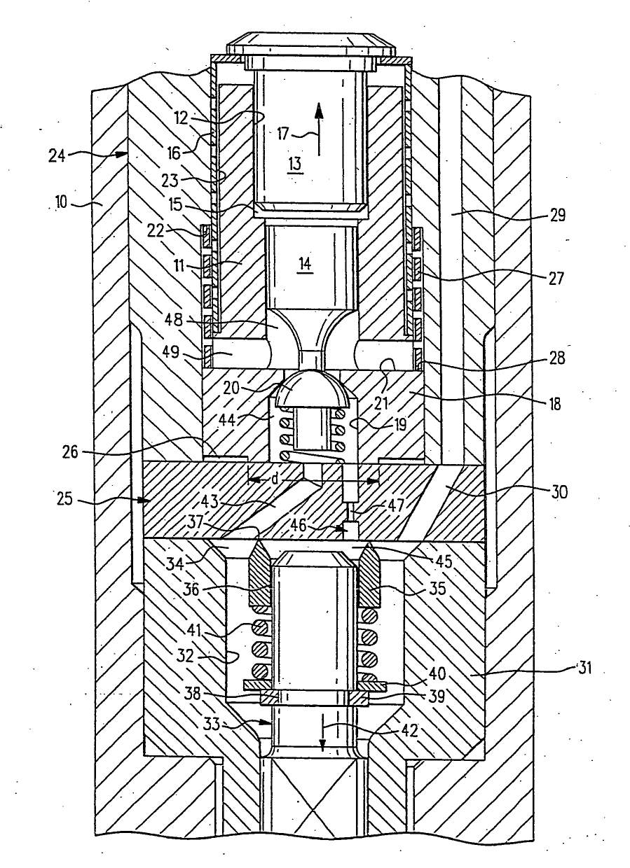

### PRIOR ART

The invention relates to an injector as generically defined by the preamble to claim 1.

A CR injector of this type is known from German Patent Disclosure DE 199 36 668 A1. A similar injector is also shown by DE 102 41 462 A1. A CR injector in which the booster piston is actuated by a piezoelectric actuator is known from German Patent DE 195 19 191 C2.

In general, such injectors require comparatively major engineering effort and expense at the sealing faces, especially in the high-pressure region.

The object of the invention is to reduce this effort and expense at the sealing faces.

### ADVANTAGES OF THE INVENTION

According to the invention, this object is attained, in an injector of the generic type defined at the outset, by the definitive characteristics of claim 1.

Advantageous refinements of the fundamental concept of the invention can be learned from claims 2-10.

By means of the invention, an integration of the valve plate into the retaining body that receives the booster piston is accomplished. This advantageously means that one complete sealing level is dispensed with. The entire system is simplified substantially as a result, and more-economical production of the injector is made possible.

### DRAWING

For further illustration of the invention, an exemplary embodiment is used, which is shown in the drawing and described in detail below. The drawing—in a fragmentary view—shows an embodiment of a CR injector in vertical longitudinal section.

### DESCRIPTION OF THE EXEMPLARY EMBODIMENT

Reference numeral 10 indicates an injector body of a CR injector—intended in particular for use in diesel engines. A sleevelike booster housing 11 with an offset central axial bore 12 is located in the injector body 10, and a piezoelectric actuator 13 and a booster piston 14 are received axially displaceably in this housing. Between the piezoelectric actuator 13 and the booster piston 14 a booster chamber 15 is embodied. The piezoelectric actuator 13 (which is connected to an electrical power supply in the usual manner which is therefore not shown) is prestressed in the direction of an arrow 17, or in other words counter to the direction of action of the piezoelectric actuator 13, by a prestressing spring 16 that surrounds the booster housing 11 and is embodied as a tube spring.

A valve plate identified overall by reference numeral 18 is embodied in the axial extension of the booster housing 11, and in an offset axial bore 19 it receives a control valve 20.

A substantial special feature is that the valve plate 18 together with the booster housing 11 forms an integral component, so that—at a level marked 21—the necessity of sealing off (from the booster housing 11) is eliminated. The booster housing 11 and the valve plate 18 are received in a continuous central axial bore 23, which is offset at 22, of a cylindrical retaining body 24. The cylindrical retaining body 24 is in turn fitted into the injector body 10.

Below the retaining body 24 and the valve plate 18 and connected sealingly to these components is a disklike closure part 25—hereinafter called a “throttle disk”. To reduce the sealing area of the valve plate 18 relative to the adjoining throttle disk 25 and as a result correspondingly reduce the required sealing forces, the valve plate 18 has an undercut 26 on its underside. The thus-reduced sealing face diameter is marked d. To create the requisite contact pressure for effectively sealing off the components 18 and 25 from one another, a prestressing element 27 embodied as a tube spring and surrounding the booster housing 11 is provided, which exerts pressure on the valve plate 18 at 28 and is braced on its back side on the shoulder 22 of the axial bore 23 of the retaining body 24.

As can also be seen from the drawing, a high-pressure conduit 29 is machined into the retaining body 24 and—via a high-pressure connection (not shown)—is in hydraulic communication with a high-pressure fuel reservoir (so-called common rail, also not shown). The high-pressure conduit 29 discharges at the lower end face of the retaining body 24, where it communicates hydraulically with a bore 30 machined into the throttle disk 25.

The throttle disk 25 is adjoined—in sealing fashion—by a nozzle body 31 having a central longitudinal recess 32, which narrows on its lower end (not shown in the drawing) to a nozzle outlet.

A nozzle needle, identified overall by reference numeral 33, is disposed axially movably in the longitudinal recess 32. A lower, tapered end of the nozzle needle 33 may be embodied conically and cooperates (not shown) with the lower end, forming a valve seat, of the longitudinal recess 32.

Through the bore 30, the fuel, which is at high pressure, reaches the longitudinal recess 32 of the nozzle body 31—via an annular chamber 34—and thus reaches the nozzle outlet.

As can also be seen from the drawing, the nozzle needle 33 is surrounded—leaving an annular gap 36—on its upper end by a sleeve part 35, which is braced with its knife edge-like upper end 37 on the underside of the throttle disk 25. A snap ring 39 inserted into an annular groove 38 in the nozzle needle 33 supports a retaining disk 40. Seated between the sleeve part 35 and the retaining disk 40 is a prestressed helical compression spring 41, which exerts a force in the direction of the arrow 42 on the nozzle needle 33, or in other words in the direction of the closing position of the nozzle needle 33.

The drawing also clearly shows that fuel at high pressure from the annular chamber 34 reaches a valve chamber 44 of the control valve 20 on the one hand—via a bore 43—and on the other reaches a control chamber 45—via the annular gap 36. The control chamber 45 attains its maximum volume in the closing position of the nozzle needle 33, in which the nozzle needle with its end closes the nozzle outlet (not shown). In the closing position, the nozzle needle 33 is retained on the one hand by the fluid pressure prevailing in the control chamber 45 and on the other by the compression spring 41.

A further bore 46 is machined into the throttle disk 25 and is hydraulically operatively connected on the one hand—via the bore 30 and the annular chamber 34—to the high-pressure conduit 29 and on the other—via a throttle bore 47—to the control valve 20. The throttle bore 47 functions as an inflow and outflow throttle.

A chamber 48 is embodied between the booster piston 14 and the control valve 20. In this region, a transverse bore 49 is machined into the booster housing 11 and serves to return leakage fuel.

1-10. (canceled)

11. In an injector for injecting fuel into combustion chambers of internal combustion engines, in particular a piezoelectric-actuator-controlled common rail injector, having control means, predominantly a piezoelectric actuator, deposed in an injector body and operable via at least one booster piston to actuate a control valve received in a valve plate; having a nozzle body with a nozzle outlet embodied on its free end toward the combustion chamber; having a nozzle needle located axially movably and actuatably in a longitudinal recess of the nozzle body; having a throttle disk, closing off the rear end remote from the nozzle outlet of the longitudinal recess and located between the nozzle body and the control valve, which throttle disk forms an opening stop for the nozzle needle and which cooperates with the rear end face remote from the nozzle outlet of the nozzle needle to thereby limit the opening stroke of the nozzle needle; and having a control chamber, embodied between the rear nozzle needle end face and the throttle disk, which chamber is in hydraulic communication with a pressure connection serving to deliver fuel, the improvement comprising a cylindrical retaining body disposed in the injector body and receiving the booster piston or pistons and the valve plate that contains the control valve.

12. The injector as defined by claim 10, wherein the valve plate is fitted into a central axial bore in the retaining body.

13. The injector as defined by claim 12, further comprising a booster housing having a central axial bore receiving the booster piston or pistons and a piezoelectric actuator, is disposed in the axial bore of the retaining body, above the valve plate.

14. The injector as defined by claim 11, wherein the retaining body rests with its lower end face toward the nozzle body flatly and sealingly on an adjoining upper end face of the throttle disk.

15. The injector as defined by claim 12, wherein the retaining body rests with its lower end face toward the nozzle body flatly and sealingly on an adjoining upper end face of the throttle disk.

16. The injector as defined by claim 13, wherein the retaining body rests with its lower end face toward the nozzle body flatly and sealingly on an adjoining upper end face of the throttle disk.

17. The injector as defined by claim 11, wherein that the valve plate is sealingly braced against the upper end face of the throttle disk by a prestressing element.

18. The injector as defined by claim 12, wherein that the valve plate is sealingly braced against the upper end face of the throttle disk by a prestressing element.

19. The injector as defined by claim 13, wherein that the valve plate is sealingly braced against the upper end face of the throttle disk by a prestressing element.

20. The injector as defined by claim 14, wherein that the valve plate is sealingly braced against the upper end face of the throttle disk by a prestressing element.

21. The injector as defined by claim 17, wherein the prestressing element that presses the valve plate against the throttle disk is braced on its back side on a shoulder of the axial bore of the retaining body, and thus is braced on the retaining body.

22. The injector as defined by claim 17, wherein the valve plate, comprises an undercut on its lower end face toward the throttle disk, which undercut serves to reduce the sealing area of the valve plate with respect to the throttle disk.

23. The injector as defined by claim 21, wherein the valve plate, comprises an undercut on its lower end face toward the throttle disk, which undercut serves to reduce the sealing area of the valve plate with respect to the throttle disk.

24. The injector as defined by claim 17, further comprising a tube spring which serves as the prestressing element and is disposed in the axial bore of the retaining body surrounding the booster housing over part of its length.

25. The injector as defined by claim 21, further comprising a tube spring which serves as the prestressing element and is disposed in the axial bore of the retaining body surrounding the booster housing over part of its length.

26. The injector as defined by claim 22, further comprising a tube spring which serves as the prestressing element and is disposed in the axial bore of the retaining body surrounding the booster housing over part of its length.

27. The injector as defined by claim 17, further comprising a piezoelectric actuator prestressed in the injector body by a spring, the prestressing spring of the piezoelectric actuator simultaneously serving as the prestressing element for the valve plate.

28. The injector as defined by claim 21, further comprising a piezoelectric actuator prestressed in the injector body by a spring, the prestressing spring of the piezoelectric actuator simultaneously serving as the prestressing element for the valve plate.

29. The injector as defined by claim 22, further comprising a piezoelectric actuator prestressed in the injector body by a spring, the prestressing spring of the piezoelectric actuator simultaneously serving as the prestressing element for the valve plate.

30. The injector as defined by claim 1 1, wherein the booster housing and the valve plate form one integral component.
